(19) United States
(12) Patent Application Publication
(10) Pub. No.: US 2014/0261938 A1
(43) Pub. Date: Sep. 18, 2014

(54) VARIABLE HEIGHT GROOVES IN MULTIPLE WEAR LAYER TREADS FOR RETREADED TIRES

(71) Applicants: E. Bruce Colby, Greenville, SC (US); Dimitri G. Tsihlas, Greer, SC (US); Cesar E. Zarak, Simpsonville, SC (US)

(72) Inventors: E. Bruce Colby, Greenville, SC (US); Dimitri G. Tsihlas, Greer, SC (US); Cesar E. Zarak, Simpsonville, SC (US)

(73) Assignees: MICHELIN RECHERCHE ET TECHNIQUE, S.A., Granges-Paccot (CH); COMPAGNIE GENERALE DES ETABLISSEMENTS MICHELIN, Clermont-Ferrand (FR)

(21) Appl. No.: 14/354,637

(22) PCT Filed: Oct. 31, 2011
(86) PCT No.: PCT/US2011/058684

§ 371 Date: Apr. 28, 2014

(51) Int. Cl. B60C 11/13; B60C 11/02; B29D 30/56

(52) U.S. Cl. CPC B60C 11/13; B29D 30/56; B60C 11/02; B60C 2011/0355
USPC 152/209.25; 156/96

(57) ABSTRACT

Particular embodiments of the present invention include multi-wear layer treads having variable depth grooves for retreaded tires, retreaded tires, and methods of forming retreaded tires. In particular embodiments, such multi-wear layer tire treads include a thickness bounded depthwise by a top side configured to engage a ground surface during tire operation and a bottom side configured for attachment to a tire carcass, the thickness extending laterally between opposing side edges and longitudinally in a lengthwise direction of the tread. Such tread may further include a top groove extending a variable depth into the tread thickness from the top side, the top groove having a groove bottom that varies depthwise within the tread thickness to form multiple wear layers. In other embodiments, top grooves may or may not be variable depth grooves, while the tread further include a bottom groove extending a variable depth into the tread thickness from the bottom side.

### BACKGROUND OF THE INVENTION

1. Field of the Invention

This invention relates generally to treads for retreaded tires, and more particularly, to precured treads having multiple wear layers with grooves arranged along a bottom side of the tread.

2. Description of the Related Art

When retreading tires, it is generally known to replace the tread with a new precured tread. In doing so, a tread is generally formed having grooves arranged along an outer side of the tread. In particular instances, grooves may also be arranged along an inner or bottom side of the tread to provide one or more tread wear layers, where different tread features are exposed as the tread wears depthwise into a thickness of the tread.

When retreads include only top grooves, the grooves within a retread generally extend a constant (i.e., fixed) depth into the tread, with the exception of wear bars and tie bars that protrude from the bottom surface a small radial distance, for a small circumferential distance. Aside from that, however, the depth is constant. Accordingly, the surface void available to a top surface, whether new or worn, is generally constant except for the change in the width of the groove as the groove wears from the top surface a fixed, constant distance to the bottom of the groove. Furthermore, in order to provide the structural rigidity necessary to cure, handle, and apply the precured tread to the tire and to cure the assembly, the groove depth of the precured tread is generally less than the full thickness of the tread by up to 5 mm. This remaining thickness is often referred to as tread-under-groove (TUG). In a conventional retreaded tire, the tire is removed from service before the tread is worn down to the groove bottom; thus, the TUG is not directly used in the wear process.

When a tread includes both top and bottom grooves spaced laterally across the tread, the top and bottom grooves overlap depthwise such that when the tread wears, both the top and bottom grooves are concurrently exposed to the worn top side of a subsequent wear layer before reaching the bottom (i.e., the full depth) of the top groove to complete the transition from the top groove to the bottom groove. An advantage of this structure over the conventional tread described above is that the full thickness of the tread can now be used in the wear process, i.e., the tread can be worn into the original TUG. In some cases, however, it may not be possible to make use of the whole tread thickness, since the distance in a radial direction from the bottom of the groove on the top side and the top of the groove on the bottom side must be greater than the minimum amount of skid depth that would normally have to be present to prevent removal of the tire from service. Furthermore, when the concurrent exposure of the top and bottom groove arises, the full length of each the top and bottom groove is exposed because the grooves are constant depth. In such instances, a significant increase in surface void may occur. This may result in a decrease in tire traction as the tread pattern evolves from the surface design to the base design. In any event, because the full length of both the top and bottom grooves are concurrently exposed for a given range of the state of wear, and because of the presence of the hidden voids in the original tread ribs, the local rigidity or stiffness of the tread can also decrease.

Accordingly, there is a need to provide an arrangement of top and bottom grooves that provides a selective exposure of the top and bottom grooves in a subsequent wear layer—in lieu of concurrently exposing a full length of each of a top and bottom groove along a worn top side of a subsequent wear layer, thus maintaining a relatively constant rubber-to-void ratio over the wear life of the retreaded tire. This could also serve to maintain a relatively constant tread element stiffness as the tread wears down. Finally, there is a need to minimize the transition between the top and bottom grooves, and in particular instances, to provide a new tread having substantially full depth grooves, reducing the amount of rubber that would have to be removed from the carcass to facilitate tire retreading, and reducing the thickness and weight of the precured tread.

### SUMMARY OF THE INVENTION

Particular embodiments of the present invention include treads having variable depth grooves. Such embodiments include a tire tread having a thickness bounded depthwise by a top side configured to engage a ground surface during tire operation and a bottom side configured for attachment to a tire carcass, the thickness extending laterally between opposing side edges and longitudinally in a lengthwise direction of the tread. Such tread further includes a top groove extending a variable depth into the tread thickness from the top side, the top groove having a groove bottom that varies depthwise within the tread thickness to form multiple wear layers.

In other embodiments, a tire tread includes a thickness bounded depthwise by a top, ground-engaging side and a bottom side, the thickness laterally between opposing side edges and longitudinally in a lengthwise direction of the tread. Such treads further include one or more top grooves extending a particular depth into the tread thickness from the top side. Still further, such treads include one or more bottom grooves extending a variable depth into the tread thickness from the bottom side, the one or more bottom grooves each having a bottom that varies depthwise as each of the bottom extends lengthwise along the tread.

Further embodiments of the multi-wear layer tire tread include a thickness bounded depthwise by a top side configured to engage a ground surface during tire operation and a bottom side configured for attachment to a tire carcass, the thickness extending laterally between opposing side edges and longitudinally in a lengthwise direction of the tread. The tread may further include a top groove extending a particular depth into the tread thickness from the top side arranged adjacent a bottom groove extending a particular depth into the tread thickness from the bottom side. Such tread may also include a connector separating the adjacent top and bottom grooves.

Particular embodiments of such methods of forming a retreaded tire include the step of providing a tire tread having a thickness bounded depthwise by a top side configured to engage a ground surface during tire operation and a bottom side configured for attachment to a tire carcass, the thickness extending laterally between opposing side edges and longitudinally in a lengthwise direction of the tread, and a top groove extending into the tread a variable depth from the top side of the tread whereby a bottom of the top groove is arranged a variable depth from the top side or a bottom groove extending into the tread a variable depth from the bottom side of the tread whereby a bottom of the bottom groove is arranged a variable depth from the bottom side. Such methods may further include the steps of arranging the tire tread overtop the tire carcass and bonding the tire tread to the tire carcass.

The foregoing and other objects, features and advantages of the invention will be apparent from the following more detailed descriptions of particular embodiments of the invention, as illustrated in the accompanying drawings wherein like reference numbers represent like parts of the invention.

### DETAILED DESCRIPTION OF THE DRAWINGS

FIG. 1 is a front sectioned partial perspective view of a retreaded tire comprising a tread arranged atop a tire carcass.

FIG. 2 is a front sectional view of the tread of FIG. 1 for application to a tire carcass to form a retreaded tire.

FIG. 3 is a side sectional view the tread of FIG. 2 taken along line 3-3, the sectional view showing a variable depth groove arranged along a bottom or inner side of the tread according to an embodiment of the invention, wherein the groove is a longitudinal or circumferential groove and the depth of the groove extends lengthwise along a stepped path.

FIG. 4 is a side sectional view the tread of FIG. 2 taken along line 4-4, the sectional view showing a variable depth groove arranged along a top or outer side of the tread in association with the grooves arranged along the bottom surface as shown in FIG. 3 according to an embodiment of the invention, where the groove arranged along the top surface is a longitudinal or circumferential groove and the depth of the groove extends lengthwise along a stepped path.

FIG. 5 is a side sectional view of the tread of FIG. 2 as generally shown in FIG. 3 according to an alternative embodiment, wherein the groove depth extends lengthwise along a curvilinear path.

FIG. 6 is a side sectional view of the tread of FIG. 2 as generally shown in FIG. 4 according to an alternative embodiment, wherein the groove depth extends lengthwise along a curvilinear path.

FIG. 7 is a side sectional view of the tread of FIG. 2 according to an alternative embodiment, where the groove depth extends lengthwise in a curvilinear path having peaks that extend longer than corresponding valleys.

FIG. 8 is a front sectional view of a tire tread according to an alternative embodiment, where the arrangement of grooves along the top and bottom sides provides a top groove arranged over top a bottom groove with a thickness of tread arranged there between.

FIG. 9A is a side sectional view of the tread of FIG. 8 taken along line 9A-9A, the view showing top and bottom grooves forming a substantially full depth groove separated by a connector extending lengthwise along a curvilinear or otherwise variable depth path.

FIG. 9B is a side sectional view of a tread showing an alternative embodiment of the tread shown in FIG. 9A showing a full depth groove extending the full thickness of the tread, the tread including a connector extending across the full depth groove and extending lengthwise along a curvilinear or otherwise variable depth path. The connector also has a thickness that varies along the length of the connector.

FIG. 10 is a top view of the tread of FIG. 9A showing the top longitudinal or circumferential grooves arranged along the top side of the tread, the exposed grooves forming surface void along the top side of the tread.

FIG. 11 is a top sectional view of the tread of FIG. 9A taken along line 11-11, the view showing the top and bottom grooves taken along an intermediate wear layer of the tread, the exposed grooves forming surface void along the wear layer's top side.

FIG. 12A is a front sectional view of the tire tread of FIG. 2 shown arranged atop a tire carcass according to an alternative embodiment of FIG. 1, where bottom grooves of the tread are aligned with tread grooves arranged in the tire carcass.

FIG. 12B is a front sectional view of an alternative tire tread of FIG. 12A shown arranged atop a tire carcass according to an alternative embodiment of FIG. 1, where top grooves are arranged atop bottom grooves of the tread, each of which are aligned above tread grooves arranged in the tire carcass.

FIG. 13 is a front sectional view of a tire tread having variable depth top grooves extending the full depth or thickness of the tread.

FIG. 14 is a side sectional view of the tread of FIG. 13 taken along the line 14-14 showing a top groove extending longitudinally along a non-linear path between the top side and the bottom side.

FIG. 15 is a partial front sectional view of the tire tread shown in FIG. 8 in accordance with an alternative embodiment, the tire tread including a connector or separator extending laterally or transversely along a non-linear path between stacked top and bottom longitudinal grooves, the path generally forming a connector having an inverted U-shaped cross-section.

FIG. 16 is a partial front sectional view of the tire tread shown in FIG. 8 in accordance with an alternative embodiment, the tire tread including a connector or separator extending laterally along a linear path between stacked top and bottom longitudinal grooves, the transverse orientation of the connector rotating or becoming angularly displaced as the connector extends longitudinally along the connector length such that its arrangement varies transversely across a width of the connector.

FIG. 17A is a partial front sectional view of the tire tread shown in FIG. 8 in accordance with an alternative embodiment, the tire tread including a connector or separator extending laterally or transversely along a linear, laterally-inclined path between stacked top and bottom longitudinal grooves, the path also extending between inner and outer sides of the tread.

FIG. 17B is an alternative to the tread of FIG. 17A, whereby the connector varies in thickness and in inclination along a length of the connector.

FIG. 18 is a partial front sectional view of the tire tread shown in FIG. 8 in accordance with an alternative embodiment, the tire tread including a connector or separator extending laterally along a non-linear path between stacked top and bottom longitudinal grooves, the path generally forming a connector having a V-shaped cross-section and extending between inner and outer sides of the tread.

FIG. 19 is a partial front sectional view of the tire tread shown in FIG. 8 in accordance with an alternative embodiment, the tire tread including a connector or separator extending laterally along a linear, laterally-inclined path between stacked top and bottom longitudinal grooves, the path also extending between inner and outer sides of the tread.

FIG. 20 is a partial front sectional view of the tire tread shown in FIG. 8 in accordance with an alternative embodiment, the tire tread including a connector or separator extending laterally along a non-linear path between laterally adjacent top and bottom longitudinal grooves, the path also extending between inner and outer sides of the tread.

### DETAILED DESCRIPTION OF PARTICULAR EMBODIMENTS

Particular embodiments of the present invention provide tire treads for use in cold retreading or manufacturing of retreaded tires. In cold retreading, a tread is molded, such as in a flat mold, for example, and pre-cured prior to application to a tire carcass. The new tread may be fully or partially cured prior to its application upon a tire carcass to form a pre-cured tread. Subsequently, the pre-cured tread is arranged or placed atop a pre-existing or used tire carcass. The tire carcass may be prepared to receive the new tread by any known means, such as by buffing, grinding, abrading, or cutting the prior tread from the carcass. Prior to applying the tread to the tire carcass, a bonding material may be arranged between the new tread and the tire carcass to promote adhesion and bonding between the tread and the tire carcass. The bonding material may comprise any known material suitable for its intended purpose of bonding the new tread to the tire carcass. For example, the joining material may comprise an adhesive or material curable by way of vulcanization, such as natural or synthetic rubber or any other elastomeric and/or polymeric material, which is commonly referred to as liaison rubber or cushion gum.

Tire treads are often formed to include a tread pattern along an outer side or face (i.e., a top side or face) of the tread for engagement with a ground surface during tire operation. The tread pattern includes grooves arranged along the top side, where such grooves may comprise longitudinal and/or lateral grooves. Longitudinal grooves form circumferential grooves when the tread is arranged along a tire. Grooves arranged along the top side are referred to herein as outer or top grooves (or outer or top-side grooves). Such treads may further include submerged voids comprising grooves arranged along an inner side (i.e., a bottom side or face) of the tread. These grooves are referred to herein as inner or bottom grooves (or inner or bottom-side grooves) and may also comprise circumferential and/or lateral grooves. With reference to FIGS. 1-2, an exemplary retreaded tire is shown. Retreaded tire 10 includes a tread 12 arranged atop a tire carcass 14 with bonding material 15 arranged there between. The tread 12 includes a top side or face 16 (i.e., an outer side) and a bottom side or face 18 (i.e., an inner side). A tread pattern is arranged along top side 16, the pattern being formed by a plurality of top grooves 20 (i.e., top-side grooves). The exposed portion of the top grooves arranged along the top side or face represents surface void, while the remaining tread surface along the top side forms contact surface for engaging a ground surface during tire operation. Surface void generally provides access to volumetric void, which generally equals the volume of the void extending into the tread from the top side. Top grooves 20 comprise longitudinal grooves 20_{long} (also referred to as circumferential grooves, at least when installed along a tire carcass) and lateral grooves 20ₜₐₜ. Longitudinal grooves 20_{long} may extend longitudinally in a lengthwise direction of the tread without extending circumferentially prior to annular arrangement upon a tire carcass 14, such as when formed in a flat mold, for example. Lateral grooves 20ₜₐₜ extend lengthwise in a widthwise or lateral direction of the tread. The arrangement of top grooves 20 may form tread blocks or elements 22 arranged along outer side 16. A rib 24 may comprise a single tread block 22 formed between laterally spaced longitudinal grooves 20_{long} (see solid ribs 24a) or between a longitudinal groove and a lateral side of the tread, or an arrangement or array of tread blocks arranged longitudinally or circumferentially along a length of the tread (see ribs 24b).

Also shown in FIGS. 1-2 are bottom grooves 26 which provide, in combination with top grooves 20, one or more submerged wear layers, where the submerged bottom grooves 26 become exposed to a worn top side 16 after sufficient tread has been worn from the tread 12. Just as top grooves 20 may comprise longitudinal or lateral grooves, so too may bottom grooves 26 comprise lateral or longitudinal grooves. In the embodiment shown in FIGS. 1-2, bottom grooves 26 comprise longitudinal grooves, which are shown to be arranged between top grooves or between top grooves and the lateral sides of the tread. It is understood, however, that top grooves 20 and bottom grooves 26 may be relationally positioned in any other arrangement, which includes arranging the top groove adjacent the bottom groove—such as in a side-by-side arrangement or arranging the top groove over top the bottom groove, for example, where at least a portion of the width of the top groove is arranged over top the bottom groove width. In particular embodiments, the entire width of a top or bottom groove is aligned to extend within a width of the other of the top and bottom groove, which is generally shown by example in FIGS. 8, 15-19. In further embodiments, the centerline of the top groove is aligned with the centerline of the bottom groove, which is generally shown by example in FIGS. 8, 15, 16, and 18. While it may be shown that the top and bottom grooves may have a variable depth extending within a thickness of the tread, however, it is understood that when a top groove is arranged over top a bottom groove, the depths of each groove may remain constant or one may vary.

In particular embodiments, the inventive treads include top and/or bottom grooves that vary in depth within a thickness of the tread, or, in other words, are variable-depth grooves. In such instances, a groove has a bottom that varies depthwise within a thickness of the tread. Extending depthwise means extending a depth into or within a tread thickness. It is understood that any wear indicator or stone ejector may extend outwardly from the groove bottom, and does not form a portion of the groove bottom such that a groove having a wear indicator and/or a stone ejector arranged along the groove bottom does not form a variable depth groove. The variable depth provides additional tread in desired locations to control tread rigidity. The additional tread, or lack thereof, may also be employed to control surface void content, such as to alter the amount of tread and/or void surface present along the top, ground-engaging side of the tread, whether in a new or worn state. In other words, variable depth grooves are capable of controlling the quantity of top and bottom grooves and surface void and volumetric void present at any worn stage of the tread by way of the top side. Controlling surface void also controls the top side access to volumetric void contained within each recessed void exposed to the top side. For example, once a bottom groove becomes exposed to the top side as the tread wears, the top side now has access to the groove volume, which is referred to as void volume. With reference to the embodiment of FIGS. 1-2, top longitudinal grooves 20_{long} and bottom grooves 26 are variable depth grooves. The variability of any top and/or bottom groove depth, whether or not both top and bottom grooves are present, provides a multi-wear layer tread that evolves as the tire wears. In the embodiment shown, the variable depth submerged bottom grooves 26 become exposed to the outer tread side 16 at different longitudinal locations after sufficient tread has been worn from the tread 12. In particular embodiments, the surface void of the outer side is generally the same when the tire is unworn and worn, that is, the surface void along the outer side is generally the same when arranged along an initial wear layer and when arranged along a worn or lower wear layer. In other embodiments, the surface void of the top and bottom grooves arranged along the worn top side of the subsequent wear layer is approximately equal to 75% to 125% the surface void of the original top surface of the tread. For example, it may be desirable to increase surface void for each subsequent wear layer as the tire wears and the skid depth decreases.

With reference to FIGS. 2-6, variable depth top and bottom grooves 20, 26 vary in depth between a minimum depth Dₘᵢₙ and a maximum depth Dₘₐₓ. Generally, the minimum depth Dₘᵢₙ may be zero while the maximum depth Dₘₐₓ may be equal to or substantially equal to the total tread thickness T for any top or bottom groove. In the particular embodiment shown, top grooves 20_{long} vary depthwise between a minimum depth Dₘᵢₙ arranged below top side 16 and a maximum depth Dₘₐₓ arranged within the tread thickness above bottom side 18. For example, the top groove depth may vary between a minimum depth and a maximum depth, the difference between the minimum depth and the maximum depth being approximately equal to or greater than 10% of the maximum depth in particular embodiments. In other variations, the difference may be approximately equal to or greater than 25%, 50%, or 75% of the maximum depth in other particular embodiments. By further example, the bottom groove may vary between a minimum depth and a maximum depth, the difference between the minimum depth and the maximum depth being approximately equal to or greater than 10% of the maximum depth in particular embodiments. In other variations, the difference may be approximately equal to or greater than 25%, 50%, or 75% the maximum depth in other particular embodiments. By further example, the difference between the minimum and maximum depth of the bottom groove may be at least 1 millimeter (mm), 2 mm, or 5 mm in certain instances, for example.

A groove depth that is substantially equal to tread thickness T generally means that a very thin portion of the tread extends across the width of the groove, such as along a top or bottom portion of the groove adjacent the top or bottom side of the tread, respectively. This very thin portion may be sufficiently thin that it may be abraded or buffed off when preparing the tread for application to a tire carcass, for example. When a top or bottom groove extends the full tread thickness T, a portion of such groove is exposed to the opposing side of the tread. For example, if a variable depth bottom groove 26 extends the full tread thickness T, a length of the groove will breach a surface arranged along the top side 16 of the tread to form a surface void along the outer tread surface. Likewise, a variable depth top groove 20 may extend fully to breach a surface arranged along the bottom side 18 (i.e., a bottom side surface) to form a surface void along the bottom side. An exemplary variable, full depth top groove 20_{long} is shown in FIG. 13. This is achievable because the groove depth varies for each such groove. While the figures show all of the top and bottom longitudinal grooves as being variable depth grooves, it is understood that less than all (i.e., a portion) of the top and/or bottom grooves may comprise a variable depth groove.

The variability of the depth of any top or bottom groove 20, 26 may vary as desired, which includes extending longitudinally along any linear or non-linear path (i.e., each may vary depthwise linearly or non-linearly). For example, with reference to FIGS. 3-4, a variable depth bottom groove 26 and a variable depth top groove 20 are shown, each having a corresponding depth D₂₆, D₂₀ (or groove bottom) extending longitudinally along a path defining a longitudinal groove profile (as viewed along a plane extending depthwise and in a longitudinal direction of the groove, such as is shown in FIGS. 3-6 for a longitudinal groove). By further example, with reference to FIGS. 3-4, the longitudinal groove profile extends along a non-linear path representing a step-function, which comprises a plurality of rectilinear segments. A non-linear path comprised of rectilinear segments also includes a zigzag path. By further example, with reference to FIGS. 5-6, the depth D₂₆ of a bottom groove 26 and the depth D₂₀ of a top groove 20 are shown extending longitudinally in a non-linear, curvilinear path representing a wave-function to provide a particular depth profile. In particular, the depthwise path of each groove in FIGS. 5-6 is a repeating, sinusoidal path, whereby the groove depths extend along a consistently alternating, repeating path defined by a consistently repeating function. Any groove described above can be described as having a maximum depth or a groove bottom that extends longitudinally in any direction and path, which may be linear or non-linear. For example, in one embodiment, the tread arranged below the groove bottom may have a consistent thickness or may vary in thickness from zero to about 4 mm, which includes providing an effective groove depth equal to the approximately the full tread thickness. Accordingly, it is understood that the depth of each groove (e.g., the maximum depth Dₘₐₓ or the groove bottom) may extend longitudinally in any desired linear or non-linear path to form a variable depth groove.

The longitudinal paths along which the total or maximum depth extends for any variable depth groove shown in FIGS. 3-6 can be described as undulating or alternating paths, where the maximum depth of each path undulates between various peaks 30 and valleys 32 through the thickness of the tread. For top grooves 20, a peak 30 represents the location at which the path transitions from a path of decreasing depth to a path of increasing depth, while a valley 32 represents the location at which the path transitions from a path of increasing depth to a path of decreasing depth. For bottom grooves 20, a peak 30 represents the location at which the path transitions from a path of increasing depth to a path of decreasing depth, while a valley 32 represents the location at which the path transitions from a path of decreasing depth to a path of increasing depth. It is understood that all peaks 30 within a path may be arranged at the same depth, such as is shown in FIGS. 3-6, or, in other variations, the depth of any peak 30 may be different from another peak arranged within the path (not shown). The same can be said for all valleys 32 arranged within a path. Therefore, peaks may each be arranged at the same of different depths, and the valleys may each be arranged at the same or different depths for any variable depth groove. With reference to FIGS. 3-6, for example, the peaks 30 of the top grooves 20 are locations of minimum groove depth D_{20, min} while the valleys 32 of the top grooves 20 are locations of maximum depth D_{20, max}. Further, the peaks 30 of the bottom grooves 26 are locations of maximum groove depth D_{26,max} while the valleys 32 of the bottom grooves 26 are locations of minimum depth D_{26,min}.

In each of the paths shown in FIGS. 3-6, the groove depths extend along a consistently alternating path, where the grooves depths consistently alternate between peaks and valleys (a step-function path in FIGS. 3-4, and a curvilinear, sinusoidal path in FIGS. 5-6). However, as suggested above, an undulating path may not consistently undulate. In other embodiments, for example, the depthwise paths may be such that the peaks are larger in amplitude or larger in length than the valleys, or vice versa. By further example, with reference to FIG. 7, the peaks 30 may endure for a longer distance before alternating toward a shorter-enduring valley 32, or vice versa. In certain embodiments, the thickness of the connecting portion (i.e., a connector) between upper grooves located directly over lower grooves may vary as the connecting portion extends in a lengthwise direction, or, in other words does not remain constant along the longitudinal path, such as for the purpose of reducing the non-void portion of the groove that appears during the wear process. For example, with reference to FIG. 9A, the connector 28 has a constant thickness while the connecting portion in FIG. 9B has a variable thickness along the length of the connector 28, although each connecting portion extends a variable depth within the tread thickness. For similar reasons, the widthwise extension of the connecting portion may vary in elevation and/or thickness within the thickness of the tread. In any event, the path along which the groove bottom extends may comprise any desired path, which may undulate in any arbitrary or constantly repeating path. Providing a groove that undulates in any desired manner may provide a tread pattern having certain desired qualities, such as when desiring to alter the tread rigidity or stiffness, to provide a particular surface or volumetric void arrangement, or to improve the noise characteristics of the tread, for example.

As an alternative description of the variable depth grooves, peaks may be referenced as raised portions of a top or bottom groove, and valleys referenced as recesses of a top or bottom groove. For example, with reference to top grooves 20 in FIGS. 3-6, peaks 30 represent a raised area or portion of each top groove 20 extending outwardly from the maximum groove depth Dₘₐₓ or groove bottom toward top side 16. Conversely, valleys 32 represent a recess extending deeper into the tread thickness T toward bottom side 18 from the minimum groove depth Dₘᵢₙ. With regard to the bottom groove 26, peaks 30 represent a recess extending into the tread thickness T toward top side 16 from a minimum groove depth Dₘᵢₙ, while valleys 32 represent a raised portion of the groove extending outwardly toward the bottom side 18 from a maximum groove depth Dₘₐₓ.

With reference to FIG. 2, top and bottom grooves 20, 26 have a width W. It is understood that the widths W of top and bottom grooves 20, 26 may comprise any desired width, which may remain constant or vary as each groove extends longitudinally along the tread length and/or as each groove extends depthwise within the tread thickness T. For example, with reference to top grooves 20, such grooves narrow in width W as each extends into the tread thickness T. By further example, bottom grooves 26 widen as each extends into the tread thickness T, which can be referred to as a groove having a negative draft angle.

In an additional effort to improve tread performance, such as tread rigidity, void arrangement, and noise characteristics, for example, it is also understood that any groove 20, 26 along the top side 16 and/or the bottom side 18 may have a different depth and a longitudinally extending depthwise profile relative to the other grooves. It is also understood that the arrangement of each top and bottom groove 20, 26 relative to other top and bottom grooves may vary as desired to achieve any desired tread characteristics. For example, laterally spaced variable depth top and bottom grooves 20, 26 may be arranged to overlap each other. For example, with reference to FIGS. 4 and 6, it can be seen that laterally spaced top and bottom grooves 20, 26 overlap each other depthwise within the tread thickness T by a distance Dₒ—that is, where at least a portion of the bottom groove 26 extends to a depth below which the top groove 20 extends. This overlap distance Dₒ may comprise any desired distance from zero to the full tread thickness T. Further, laterally spaced top and bottom grooves 20, 26 may overlap intermittently or periodically, which is shown in FIGS. 4 and 6, for example. It is also understood that laterally top and bottom grooves 20, 26 may overlap the entire length of either or both grooves 20, 26. In such arrangements, the overlap depth Dₒ may vary or remain constant.

An overlap can be achieved by generally misaligning or shifting the longitudinal extension and depthwise extension of the groove-bottom (also referred to as “the longitudinal/depthwise profile”) of the top groove 20 in a longitudinal direction and/or in a depthwise direction relative at least a portion of the longitudinal/depthwise profile of the bottom groove 26 within the tread thickness. For example, FIG. 4 shows the longitudinal/depthwise profile of a top groove 20 shifted depthwise below at least a portion of the bottom groove 26. By further example, with reference to FIGS. 4 and 6, an overlap can be achieved between laterally adjacent top and bottom grooves 20, 26 by arranging the peak 30 of the top groove 20 between adjacent peaks 30 of an adjacent bottom groove 26, or vice versa by generally arranging the valley 32 of the top groove 20 between adjacent valleys 32 of an adjacent bottom groove 26. In particular, with reference to FIG. 6, the peaks 30 of the top groove 20 are aligned longitudinally with the valleys 32 of the bottom groove 26, while the valleys 32 of the top groove 20 are aligned longitudinally with the peaks 30 of the bottom groove 26.

It is understood that the longitudinal/depthwise profiles of overlapping laterally spaced apart top and bottom grooves 20, 26 may extend along similarly shaped paths or dissimilarly shaped paths. For example, with reference to FIG. 4, the longitudinal/depthwise profiles of the top and bottom grooves 20, 26 extend along similarly shaped paths, but because the paths are shifted depthwise and longitudinally relative one another, the depths overlap as the paths are misaligned longitudinally and depthwise. Similar paths are also shown in FIG. 6, whereby said paths are shifted longitudinally to misalign the paths and create a depthwise overlap of the paths. In particular, the curvilinear paths of the top and bottom grooves 20, 26 of FIG. 6 are shifted by half a phase such that minimum depth D_{20, min}, D_{26, min} of each groove 20, 26 is longitudinally aligned with the maximum depth D_{20, max}, D_{26, max} of the other groove 20, 26. It is understood, however, that adjacent top and bottom variable depth grooves 20, 26 may have longitudinal/depthwise profiles that extend along the same path and are substantially aligned longitudinally and depthwise. It is also understood that a set of n grooves 20, 26 could be shifted longitudinally with respect to each other one or a half cycle length divided by n, for example, to obtain a constant average groove effect around the circumference of the tire.

In the embodiments discussed above, the arrangement of top and bottom grooves forms a tread having multiple wear layers, the wear layers becoming exposed as the tread wears deeper into the tread thickness from an outer tread side. For example, with reference to FIG. 4, the tread shown includes 5 wear layers L₁, L₂, L₃, L₄, and L₅. The first wear layer L₁ is the new wear layer, while the remaining wear layers become exposed when the outer surface of the outer side wears through the upper layer(s). In FIG. 6, according to another embodiment, an arrangement of top and bottom grooves forms a tread having three wear layers L₁, L₂, and L₃. It is understood that a tread having any quantity of wear layers is achievable employing the bottom grooves discussed herein. By employing variable depth grooves discussed herein, the surface void arranged along each top side or face associated with each wear layer may be better controlled. When top and/or bottom grooves have depths that vary, such as along a linear or curvilinear path, for example, it can be said that the tread has multiple wear layers that are continuously evolving or changing.

As discussed above, a top or bottom groove may extend substantially the full depth or thickness of the tread. This is achievable when the groove is a variable depth groove, which may include a variable depth connector extending across the groove to provide additional rigidity to the tread as discussed above. A variable depth connector has at least one of a top or bottom side that varies in depth within a thickness of the tread. Each of the top or bottom sides that varies in depth may undulate or alternate. Each variable depth connector has a thickness that may remain constant or vary as the connector extends lengthwise. With reference to FIGS. 8-9A, a tread is shown having a substantially full depth groove 34. In the embodiment shown, the substantially full depth groove extends substantially the full thickness T of the tread and includes a thin variable depth connector or separator extending across a width of the groove to separate the top and bottom grooves. It can be said that the substantially full depth groove 34 comprises a variable depth bottom groove 26 arranged below a variable depth top groove 20, the connector 28 being arranged between the top and bottom grooves. In other words, substantially full depth groove 34 comprises a variable depth connector 28 (i.e., a connector whose arrangement varies depthwise within the thickness of the tread). The variable depth connector 28 is arranged between top and bottom grooves 20, 26. At least one or both of the top and bottom grooves 20, 26 are variable depth grooves since at least a top or bottom of the connector 28 varies in depth as the connector extends lengthwise. Just as with the lengthwise extension of variable depth top and bottom grooves 20, 26, as discussed above in association with FIGS. 2-7, the lengthwise extension may comprise any non-linear path, which may comprise, for example, a curvilinear path or a path comprised of a plurality of rectilinear segments (e.g., a zigzag or stepped path). In FIG. 9A, for example, connector 28 extends longitudinally in a sinusoidal, curvilinear path. This connector may itself vary in thickness in a longitudinal or lateral path, which may also result in a variable depth connector. The lateral path extends in a widthwise direction of the connector. An exemplarily connector of variable thickness is shown in FIG. 9B.

It is understood that connectors 28 may also extend laterally (i.e., in a widthwise direction) in any path separating top and bottom grooves 20, 26, which may or may not comprise variable depth grooves. In FIG. 8, the connectors extend laterally without any variation in depth (i.e., in a direction generally normal to a radial or depthwise direction of the tread or of a lateral centerline extending in a lengthwise direction of the tread). In other embodiments, connectors may extend in a lateral direction and/or a longitudinal direction along a path that varies in depth. Different embodiments of laterally varying connectors 28 are shown in FIGS. 15-20 for exemplary purposes. Variable depth connectors may extend along any linear or non-linear path. In FIG. 15, for example, connector 28 extends laterally along a non-linear path between stacked top and bottom longitudinal grooves 20, 26, the path generally forming a connector having an inverted U-shaped cross-section. It can be said the top groove is nested overtop the bottom groove as the bottom groove will become exposed before the top groove is eliminated as the tread wears. An aperture 40 is shown extending through the connector thickness and in fluid communication between the top and bottom grooves 20, 26, such that the gas or fluid pressure between top and bottom grooves may be equalized or such that the gas within the bottom groove may be vented to the top groove, or vice versa. A plurality of apertures 40 may be arranged along a length of any connector 28 discussed or contemplated herein. Apertures 40 may form a hole or a longitudinally extending slit, for example. In FIG. 16, connector 28 extends laterally or transversely along a linear path between stacked top and bottom longitudinal grooves, the transverse orientation of the connector rotating or becoming angularly displaced as the connector extends longitudinally along the connector length such that its arrangement varies transversely across a width of the connector. FIG. 18 depicts a connector 28 extending laterally along a non-linear path generally forming a connector having a V-shaped cross-section and extending between inner and outer sides 16, 18 of the tread. It can seen that the connector varies vertically in elevation within the tread thickness as the connector extends longitudinally.

In FIG. 17A, connector 28 extends laterally along a linear, laterally-inclined path between stacked top and bottom longitudinal grooves 20, 26. The connector also extends between inner and outer sides 16, 18 of the tread, although in other variations, such connector may not extend from either or both top or bottom sides 16, 18. In this embodiment, the connector orientation remains constant in a lengthwise direction of the tread. However, in other embodiments, the orientation of any connector 28 may change as the connector extends longitudinally. For example, with reference to FIG. 17B, the connector 28 has a variable thickness, such that the connector thickness increases as each groove decreases in depth to thereby reduce the radial inclination of the connector. The orientation of any connector may also vary due to any change in the width of any groove.

With reference now to FIG. 19, connector 28 extends laterally along a linear, laterally-inclined path between stacked top and bottom longitudinal grooves, the path also extending between inner and outer sides of the tread. Finally, in FIG. 20, connector 28 extends laterally along a non-linear path between laterally adjacent top and bottom longitudinal grooves, the path also extending between inner and outer sides 16, 18 of the tread and including a central portion extending radially in a direction normal to top and bottom sides 16, 18. It can be said that stacked top and bottom grooves 20, 26 in FIGS. 15-19 are also adjacently arranged, with a connector arranged between or separating the top and bottom grooves. Two or more top and bottom grooves 20, 26 separated by a connector may be adjacently arranged. For example, adjacent pairs of top and bottom grooves are shown in FIG. 15-20, which may extend lengthwise (i.e., longitudinally) in an undulating (i.e., variable depth) path or in a constant depth path within the tread thickness. Adjacently arranged grooves 20, 26 are closely arranged such that when the top groove is worn away, the bottom groove substitutes or is exchanged for the top groove in the lower wear layer. For example, in particular embodiments, grooves 20, 26 are adjacent one another when a connector 28 separating the grooves has a thickness of approximately 5 mm or less. In other embodiments, for example, the connector 28 has a thickness equal to or less than the groove depth of one of the grooves 20, 26.

Accordingly, connectors 28 may extend laterally along any desired path separating top and bottom grooves, where such grooves may be arranged in a radially stacked arrangement (i.e., above one another) or laterally adjacent each other. Further, changes in the depthwise arrangement of any connector 28 may be achieved by varying the cross-sectional shape and orientation of the connector as it extends longitudinally. By using connectors 28 that vary depthwise in a lateral direction (i.e., that vary in depth within the thickness of the tread), the arrangement of void within the tread may be further controlled, such that different portions of top and bottom grooves 20, 26 may become exposed at different worn depths of the tread to control the surface void along the outer, ground engaging side of the tread. This variable exposure of the top and bottom grooves may also be achieved by varying the thickness of the connector 28. By providing a variable depth connector, grooves may remain continuous along a length of the groove while the width of the groove varies, as exemplarily shown in FIGS. 17A, 17B, 17C, and 18, or remains generally constant, as exemplarily shown in FIGS. 15, 16, 19, and 20.

With continued reference to FIG. 9A, the top and bottom groove arrangement forms a substantially full depth groove 34 by virtue of the connector 28, such as when the connector 28 is sufficiently thin or when a sufficiently thin portion 29 of the connector is arranged along a top and/or bottom side 16, 18. Connector portion 29 may be the same thickness of connector 28, or may be thinner or thicker than connector 28. The substantially full depth groove 34 can become a full depth groove when the connector portion 29 is removed. Removal may occur prior to tread use during tire operation when the connector portion 29 is removed during or after the tread is removed from the mold (i.e., when the tread is demolded) to form a void or opening 36 along the corresponding top or bottom side 16, 18. This may be achieved by simply pulling the portion 29 from the tread or by cutting or abrading the portion from the tread using an abrading or cutting operation, which may comprise using an abrading tool, such as a buffing or grinding tool, a cutting tool, such as a knife. It is understood that connector portion 29 may be intentionally formed by a corresponding cavity formed within a tread mold. It is also understood that connector portion 29 may be formed during a molding operation when opposing portions of a mold sufficiently close upon each other or even into one another to prevent the formation of connector portion 29, whereby, instead of forming an opening 36 along a corresponding top or bottom side, mold flash extends along the top or bottom side to form a thin connector portion 29. In other instances, with reference to FIG. 9B, molding operations may facilitate the formation of a discontinuous connector 28, whereby a void or opening 36 is formed along (i.e., molded) into any top or bottom side 16, 18. In such instances, a full depth groove 34 is molded into the tread, in lieu of a substantially full depth groove. The molded tread 12 shown having a discontinuous undulating connector 28 with a discontinuity 38 arranged along any outer tread side 16, 18 may also represent a tread molded with a connector portion 29 arranged along an outer side 16, 18 of the tread, where the connector portion 29 was subsequently removed as previously discussed according to a material removal process. The connector 28 is also shown to have a variable thickness, that is, a thickness that varies along the length of the connector as it extends longitudinally, although said connector may extend lengthwise with a constant thickness. It is understood that the connector 28 can undulate up and down in elevation according to a repeating function or along any other arbitrary, non-repeating path.

The treads discussed in association with FIGS. 8-9B having an undulating connector 28 are characterized as having evolving wear layers, just as discussed in association with FIGS. 2-7. With reference to FIGS. 10-11, a top view of a tread is shown in new and sectioned views to evidence how the groove 36 evolves from top groove 20 to bottom groove 26 as the tread wears though a thickness of the tread and connector 28. By employing the undulating connector 28, a thinner tread may be formed as the connector provides sufficient rigidity and integrity to the tread when a connector portion 29 or void 36 is arranged along a top and/or bottom side 16, 18 of the tread to provide a substantially full or full depth groove. For example, the invention allows selective exposure of any quantity of grooves along the top, outer side of the tread through the life of the tread. It is noted that the grooves shown the figures are constant width and extend longitudinally in a linear path. It is understood, however, that the variable depth grooves of the invention may vary in width and extend longitudinally in any linear or non-linear path. In the particular embodiment shown in FIG. 2, for example, it can be envisioned that the undulations of the grooves could be such that, at any given state of wear, either the top groove 20 or the bottom groove 26 would be exposed to top side 16.

By employing the inventive features described herein, treads may be formed thinner than prior treads while maintaining tread rigidity, better controlling void arrangement, and addressing any noise issues, etc. Thinner treads may be useful when retreading tire carcasses whereby a portion of the old tread is preserved on the tire carcass. Because a portion of the old tread remains, thinner treads maybe used to reduces waste when retreading. Not only is less of the old tread removed, but also less material is used to form the new tread. In such instances when a portion of the old tread remains, the grooves in the old tread may also remain. Accordingly, a new tread having bottom grooves may be employed, the bottom grooves being aligned with the existing tread grooves in the tire carcass. For example, with reference to FIGS. 12A and 12B, a thinner tread 12 employing both top and bottom grooves 20, 26 is arranged atop a tire carcass 14 having a worn tread layer 15a, the worn tread layer including worn grooves 15b. Specifically, in FIG. 12A, the tread of FIG. 2 is arranged along the tire carcass 14, the bottom grooves 26 being laterally aligned over top the worn grooves 15b. In FIG. 12B, a tire tread 12 similar to the tread shown in FIG. 8 is arranged atop a tire carcass 14, the variable depth top grooves 20 being arranged over top the variable depth bottom grooves 26 within tread 12. The tread 12 is also arranged relative the tire carcass 14 such that the bottom grooves 26 are aligned with the worn grooves 15b. It is understood, however, that any tread discussed or contemplated herein may be arranged atop a tire carcass 14, whether or not such carcass includes worn tread grooves 15b. But by employing the treads having top and bottom grooves 20, 26 or substantially full depth or full depth grooves 34, any old groove 15b may remain useful in the retreaded tire. Prior to use on a tire, any tread discussed above and contemplated herein is arranged annularly about or overtop to tire carcass and bonded thereto to form a retreaded tire. Accordingly, the invention includes methods of forming a retreaded tire. Such methods include the step of providing any tire tread discussed or contemplated above. In particular embodiments, the tread provided has a thickness bounded depthwise by a top side configured to engage a ground surface during tire operation and a bottom side configured for attachment to a tire carcass, the thickness extending laterally between opposing side edges and longitudinally in a lengthwise direction of the tread. The tread further includes a top groove extending into the tread a variable depth from the top side of the tread whereby a bottom of the top groove is arranged a variable depth from the top side or a bottom groove extending into the tread a variable depth from the bottom side of the tread whereby a bottom of the bottom groove is arranged a variable depth from the bottom side.

Such methods may further include the step of providing a tire carcass, the tire carcass including a pre-existing tread layer. The pre-existing tread layer may include grooves arranged therein, such as, for example, longitudinal grooves extending into a thickness of the pre-existing tread layer from a top side of the pre-existing tread layer. The pre-existing tread layer may be of constant thickness or of variable thickness, such as when the layer has been exposed to uneven wear. Any grooves arranged within the pre-existing tread layer may be formed therein originally or may be subsequently formed therein by any abrading or cutting operation prior to arranging the new tread layer overtop the tire carcass. Also prior to applying the new tread layer, the pre-existing tread layer may be prepared, such as by cleaning the pre-existing tread layer and/or removing material from the pre-existing tread layer by any known means of removing tread material from the pre-existing tread layer. Such means may comprise use of any abrading, buffing, or grinding operation.

Particular embodiments of such methods may further include the step of applying a bonding layer atop the pre-existing tread layer prior to applying the new tread layer. The bonding layer is formed of any elastomeric or polymeric material that is curable. The bonding layer may be applied by any known means, such as by extrusion.

Such methods may further include the step of arranging the tire tread overtop the tire carcass such that the top or bottom groove arranged within the tire tread is arranged over top a groove arranged in a pre-existing tread layer of the tire carcass. It is understood, however, that in other embodiments, the top or bottom groove is not arranged overtop the groove of the pre-existing tread layer.

Such methods may further include the step of bonding the tire tread to the tire carcass. This step may be accomplished by any known means for curing the tread to the tire carcass. For example, the assembled retread tire (i.e., a tire carcass having a tread applied thereto) may be at least partially arranged within a curing membrane and inserted into an autoclave to apply heat and pressure to the assembled retreaded tire.

While this invention has been described with reference to particular embodiments thereof, it shall be understood that such description is by way of illustration and not by way of limitation. Accordingly, the scope and content of the invention are to be defined only by the terms of the appended claims.

What is claimed is:

1. A multi-wear layer tire tread comprising:
a thickness bounded depthwise by a top side configured to engage a ground surface during tire operation and a bottom side configured for attachment to a tire carcass, the thickness extending laterally between opposing side edges and longitudinally in a lengthwise direction of the tread; and,
a top groove extending a variable depth into the tread thickness from the top side, the top groove having a groove bottom that varies depthwise within the tread thickness to form multiple wear layers.

2. The tire tread of claim 1, where the top groove varies depthwise along the length of the top groove.

3. The tire tread of claim 1, where the top groove varies between a minimum depth and a maximum depth, the difference between the minimum depth and the maximum depth being equal to or greater than 10% of the maximum depth.

4. The tire tread of claim 1, where the difference between a minimum depth and maximum depth of the top groove is at least 2 mm.

5. The tire tread of claim 1, where the top groove depth varies between a minimum depth and a maximum depth, the maximum depth being at least substantially equal to the thickness of the tread.

6. The tire tread of claim 1 further comprising:
a bottom groove extending a variable depth into the tread thickness from the bottom side, the bottom groove having a groove bottom that varies depthwise.

7. The tire tread of claim 6, where the bottom groove varies depthwise along the length of the bottom groove.

8. The tire tread of claim 6, where the difference between a minimum depth and maximum depth of the bottom groove is at least 2 mm.

9. The tire tread of claim 6, where the bottom groove depth varies between a minimum depth and a maximum depth, the maximum depth being substantially equal to the thickness of the tread.

10. The tire tread of claim 6, where the top groove is positioned adjacent the bottom groove, the top groove and the bottom groove being separated by a connector, the connector comprising a thickness of the tread.

11. The tire tread of claim 10, where the top groove is positioned overtop the bottom groove.

12. The tire tread of claim 11, where the connector extends across a full width of at least one of the top or bottom grooves.

13. The tire tread of claim 10, where the connector separating the top and bottom grooves has a thickness that varies depthwise within the tread thickness.

14. The tire tread of claim 13, where the connecter thickness varies longitudinally along a length of the connector.

15. The tire tread of claim 13, where the connector thickness varies laterally along a width of the connector.

16. The tire tread of claim 10, where the connector separating the top and bottom grooves has a constant thickness extending longitudinally and laterally.

17. The tire tread of claim 6, where the depth of the top groove extends along a first path alternating between peaks and valleys and the depth of the bottom groove extends along a second path also alternating between peaks and valleys, the first path being arranged longitudinally relative the second path such that the peaks of the first path are longitudinally arranged between the valleys of the second path.

18. The tire tread of claim 1, where the depth of the top groove extends along a first path alternating between peaks and valleys and the depth of a second top groove extends along a second path also alternating between peaks and valleys, the first path being arranged longitudinally relative the second path such that the peaks of the first path are longitudinally arranged between the valleys of the second path.

19. The tire tread of claim 6, where the depth of the bottom groove extends along a first path alternating between peaks and valleys and the depth of a second bottom groove extends along a second path also alternating between peaks and valleys, the first path being arranged longitudinally relative the second path such that the peaks of the first path are longitudinally arranged between the valleys of the second path.

20. The tire tread of claim 1, wherein the tire tread is a new precured tread bonded to a used tire carcass.

21. The tire tread of claim 6, wherein the tire tread is a new precured tread bonded to a used tire carcass, the top groove or the bottom groove being arranged overtop a groove arranged in a pre-existing tread layer of the tire carcass.

22. The tire tread of claim 6, where the tread includes a wear layer arranged below the top side positioned a particular depth within the tread thickness, where the wear layer forms a worn top side of the tread and the bottom groove extends discontinuously along the worn top side of the subsequent wear layer.

23. The tire tread of claim 22, where the top groove extends discontinuously along the worn top side of the subsequent wear layer.

24. A method of forming a retreaded tire, the method comprising:
providing a tire tread having:
a thickness bounded depthwise by a top side configured to engage a ground surface during tire operation and a bottom side configured for attachment to a tire carcass, the thickness extending laterally between opposing side edges and longitudinally in a lengthwise direction of the tread; and,
a top groove extending into the tread a variable depth from the top side of the tread whereby a bottom of the top groove is arranged a variable depth from the top side or a bottom groove extending into the tread a variable depth from the bottom side of the tread whereby a bottom of the bottom groove is arranged a variable depth from the bottom side;
arranging the tire tread overtop the tire carcass; and,
bonding the tire tread to the tire carcass.

25. The method of claim 24, where the step of arranging the tire tread overtop the tire carcass includes arranging the tire tread overtop the tire carcass such that the top or bottom groove arranged within the tire tread is arranged overtop a groove arranged in a pre-existing tread layer of the tire carcass.

26. A multi-wear layer tire tread comprising:
a thickness bounded depthwise by a top side configured to engage a ground surface during tire operation and a bottom side configured for attachment to a tire carcass, the thickness extending laterally between opposing side edges and longitudinally in a lengthwise direction of the tread;
one or more top grooves extending a particular depth into the tread thickness from the top side; and,
one or more bottom grooves extending a variable depth into the tread thickness from the bottom side, the one or more bottom grooves each having a bottom that varies depthwise as each of the bottom extends lengthwise along the tread.

27. The tire tread of claim 26, wherein the top grooves extend depthwise a variable depth into the tread thickness.

28. A multi-wear layer tire tread comprising:
a thickness bounded depthwise by a top side configured to engage a ground surface during tire operation and a bottom side configured for attachment to a tire carcass, the thickness extending laterally between opposing side edges and longitudinally in a lengthwise direction of the tread;
a top groove extending a particular depth into the tread thickness from the top side arranged adjacent a bottom groove extending a particular depth into the tread thickness from the bottom side; and,
a connector separating the adjacent top and bottom grooves.

29. The tire tread of claim 28, where the top groove is arranged overtop the bottom groove, the connector comprising a thickness of the tread extending transversely between a width of the top groove and a width of the bottom groove.

30. The tire tread of claim 28, where the connector has a thickness, the thickness remaining constant as the connector extends lengthwise.

31. The tire tread of claim 28, where the connector separating the top and bottom grooves has a thickness that varies depthwise within the tread thickness as the connector extends lengthwise.
